(19) United States
(12) Patent Application Publication
(10) Pub. No.: US 2012/0166210 A1
(43) Pub. Date: Jun. 28, 2012

(54) LIVING ASSISTANCE SYSTEM

(75) Inventors: Dew-Anne Langcaon, Aiea, HI (US); Phillip Moran, Honolulu, HI (US); Kevin Allen, Nevada City, CA (US)

(73) Assignee: Ho'okele Health Technologies, LLC, Honolulu, HI (US)

(21) Appl. No.: 13/097,952

(22) Filed: Apr. 29, 2011

Related U.S. Application Data
(60) Provisional application No. 61/457,104, filed on Dec. 27, 2010.

(51) Int. Cl. G06Q 50/00; G06Q 40/00; G06Q 30/00

(52) U.S. Cl. 705/2; 705/26.1

(57) ABSTRACT

A system for a person receiving assistance with living activities includes a computer system providing capability (a) to provide information on an assisted person's living activities, and (b) to manage elements of commercial transactions between the assisted person and vendors. An assisted-person portal provides capability for an assisted person to initiate commercial transactions with vendors. A care-provider portal provides capability for the care provider (i) to access information about the assisted person's living activities, and (ii) to manage transactions initiated by the assisted person. Information on an assisted person's living activities may include data from sensors of the assisted person's movements, biometric data collection activity, biometric readings, and information about instrumental activities of daily living.

### CROSS-REFERENCE TO RELATED APPLICATIONS

The instant application claims priority to U.S. Provisional Patent Application 61/457,104, filed on Dec. 27, 2010, entitled “Living Assistance System”, the disclosure of which is incorporated herein by reference in its entirety.

### BACKGROUND

The inventive system described in other sections below relates to systems and methods to support a person's ability to live independently. People capable of independent living usually can manage their “activities of daily living” (“ADL”), which are skills needed in typical self care. “Basic ADL” includes such skills as bathing, dressing, feeding, ambulation, toileting, and continence. “Instrumental ADL” refers to skills beyond basic self care that allow a person to function within a community, such as housework, meal preparation, taking medications, managing money, shopping, laundry, transportation, and telecommunications (e.g., use of telephones). Different people require different levels of living assistance, and each person's assistance needs may change over time as their ADL capabilities change.

Living assistance may be, but need not be, coincident with “health care,” which refers to the maintenance and restoration of health by the treatment and prevention of disease. Medical conditions may have varying degrees of impact on a person's activities of daily living. A broken nose may require medical care while having little or no impact on a person's ability to handle finances. People may require both health care and living assistance, but the two types of support are not synonymous.

Substantial attention has been given to technology for treating medical conditions. Some attention also has been given to assisting institutionalized persons with basic activities of daily living as an adjunct to health care. For example, a patient bed-ridden with bone injuries may require assistance with bathing even if bathing is not directly a treatment for the bone injuries.

Relatively little attention has been giving to assisting persons with instrumental activities of daily living, especially in settings outside health care facilities. One such area of attention has been systems for monitoring movement and health of persons who may require assistance. Examples of such monitoring systems can be found in U.S. Pat. Nos. RE41,190; 7,733,344; 7,663,490; 7,301,463; 7,405,653, and 7,261,690. Such monitoring systems often have a goal of detecting changes in medical conditions that may require medical intervention.

### SUMMARY

An objective of the invention is to improve the quality of life for people who want to live independently but who may need or want assistance with activities of daily living. A further objective of the invention is to provide an improved system that helps caregivers support people who may need or want assistance with activities of daily living. Additional objectives of the invention include:

(1) providing a system that gives a caregiver improved information about an assisted person's wellness status and activities of daily living;

(2) providing a system that facilitates an assisted person's instrumental activities of daily living;

(3) providing a system that can be configured over time according to changing wellness and other status of an assisted person; and

(4) providing a scalable system that caregivers can configure to the needs and desires of multiple assisted persons.

These and other objectives may be achieved by providing an improved system that preferably collects, stores, and makes available to a caregiver information about an assisted person's wellness status and activities of daily living. The system also preferably provides support for the assisted person's activities of daily living, such as by facilitating shopping, home maintenance, ordering of goods and services, and/or finance management. The system also preferably provides a capability for a caregiver to configure the system according to the caregiver's evaluation of an assisted person's biometric and/or activity data, and to intervene as appropriate in the assisted person's activities of daily living.

A preferred system may collect biometric information, including without limitation the assisted person's weight, blood pressure, blood thickness, blood oxygen, temperature, and/or other physical parameters. A preferred system also may collect other wellness information, including without limitation textual notes of a caregiver's observations about the assisted person. A preferred system also may collect activity information, including without limitation the assisted person's patterns of movements about a residence, opening and closing of doors, etc. A preferred system also may collect other activity information such as shopping, telecommunications, transportation, home maintenance, and/or finance management.

A preferred system may provide capability for an assisted person to order goods and services related to activities of daily living, including, without limitation, groceries, transportation services, home maintenance services, and/or health products. A preferred system may provide a pre-configured set of ordering options so as to avoid unnecessary complication for the assisted person. A preferred system may provide financial services to settle transactions initiated by the assisted person and a financial account from which the assisted person's transactions may be settled.

A preferred system may provide a capability for a caregiver to adjust the ordering options available to the assisted person. A preferred system also may provide a capability for the caregiver selectively to approve, reject, or modify transactions initiated by the assisted person, and to initiate transactions of behalf of the assisted person. A preferred system also may allow a caregiver to replenish a financial account for the assisted person.

The summary presented here is intended to give a reader a brief introduction to an assisted living system. It is not intended to be an exhaustive or limiting description.

### BRIEF DESCRIPTION OF THE SEVERAL VIEWS OF THE DRAWING

Reference will be made to the following drawings, which illustrate preferred embodiments of the invention as contemplated by the inventors.

FIG. 1 illustrates elements of an overall architecture suitable for implementing a living assistance system.

FIG. 2 illustrates one view of many possible views that a caregiver can have through a caregiver interface.

FIG. 3 illustrates one view of many possible views that an assisted person could have through an assisted-person interface.

FIG. 4A illustrates one view of many possible views that that an assisted person could have through an assisted-person interface that exemplifies a process for ordering groceries.

FIG. 4B illustrates one view of many possible views that an assisted person could have through an assisted-person interface that exemplifies a process for ordering a transportation service.

FIG. 5 illustrates one view of many possible views that a caregiver could have through a caregiver interface that exemplifies a process of configuring the system for a particular assisted person.

FIG. 6 illustrates one view of many possible views that caregiver could have through a caregiver interface to help the assisted person with financial management.

FIG. 7 illustrates one view of many possible views that caregiver could have through a caregiver interface to help the assisted person with order management.

FIG. 8A illustrates one view of many possible views that a vendor could have through a vendor interface relating to order management.

FIG. 8B illustrates another view of many possible views that a vendor could have through a vendor interface

FIG. 9 illustrates an exemplary software architecture for an embodiment of a living assistance system with emphasis on a server system.

FIG. 10 illustrates an exemplary software architecture for an embodiment of a living assistance system with emphasis on communications.

FIG. 11 illustrates an exemplary process for an order creation process.

FIG. 12 illustrates a variation on an order process that may be used when assisted person orders a refill of a prescription.

### DETAILED DESCRIPTION OF THE INVENTION

A living assistance system as described here is envisioned primarily, but not exclusively, for use with any person who needs or desires assistance from another person for activities of daily living. A particularly suitable use is with an elderly individual whose capabilities may be diminishing because of age, illness, or injury. The elderly person may be the assisted person, while the caregiver may be an adult child, nursing professional, or other person. Other uses include, but are not limited to, persons with disabilities or injuries, and persons who have been placed under supervision, such as in prisons, halfway houses, juvenile detention facilities, etc.

A theory of operation of the system is to provide both (a) support for activities of daily living, and (b) improved ability for a caregiver to intervene and assist, as appropriate, in those activities. By way of introductory example, and without attempting to exhaustively define the architecture or limit its use, the assisted person may be an elderly parent, and the caregiver may be an adult child. The elderly parent may desire to live alone in his/her own apartment, rather than living with the adult child or in a nursing facility. An exemplary system may include sensors in the elderly parent's apartment to monitor doors, windows, medicine cabinet, bed, and motion in each room. These sensors allow a caregiver to monitor the assisted person's activities. Biometric sensors also may be installed, such as a weight scale, blood pressure monitor, pulse oximeter, thermometer, etc. As the elderly parent goes about his/her daily activities, the system stores sensor readings. The adult child may monitor the elderly parent's activities and wellness status through the system, such as by reviewing the parent's movement patterns and noticing whether the elderly person is getting up at night, leaving the residence for walks, taking medicine, monitoring his/her weight, etc. These sensors allow the caregiver to monitor the assisted person's wellness status and to adjust the level of assistance according to that wellness status, as will be discussed further below.

A preferred system also provides capability to support the assisted person with instrumental ADL's such as shopping, transportation, communications, etc. The system may include a touch screen computer through which the elderly parent can order groceries, send messages to family, order a taxi, etc. The system preferably includes financial accounting for settling transactions and a capability for the adult child to monitor the elderly parent's spending patterns and replenish accounts. The system may be used in other settings, such as an assisted living facility, nursing home, health care facility, or others.

Most preferably, the adult child could adjust the elderly parent's transaction options according to the elderly parent's wellness status. For example, if the elderly parent has diligently maintained weight targets, the caregiver could expand the menu of groceries available for ordering to more preferred foods. But if the parent has become diabetic, the caregiver could remove high-sugar items from the list of available groceries.

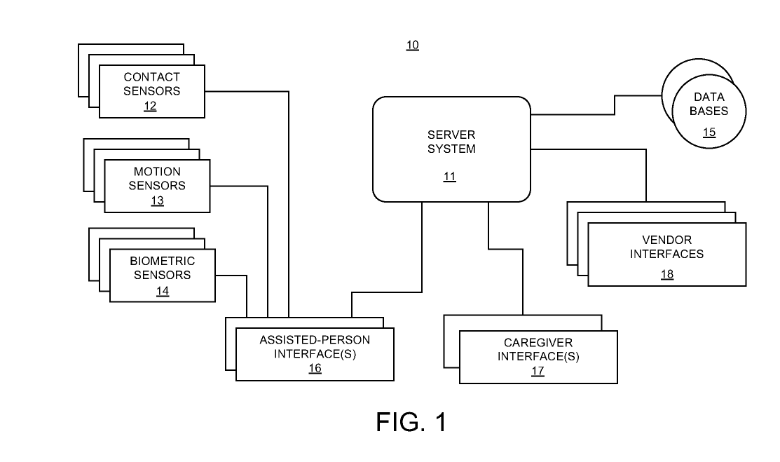

FIG. 1 illustrates elements of an overall architecture 10 suitable for implementing a living assistance system. The architecture 10 preferably includes a computer server system 11; several sensors, including one or more contact sensors 12, one or more motion sensors 13, and one or more biometric sensors 14; one or more databases 15 for storing historical sensor data, transaction data, and other data; one or more interfaces 16 for one or more assisted persons; one or more interfaces 17 for a caregiver or caregivers; and one or more interfaces 18 for vendors. It is expected, though not required, that a single system 10 would serve multiple assisted persons.

Sensors 12, 13, 14 and the assisted-person interface 16 preferably will be located at the assisted person's residence. Contact sensors 12 can most advantageously be attached to external doors, windows, and certain interior doors, such as refrigerator and medicine cabinet. A pressure sensor may be placed in the assisted person's bed. Other contact sensors may be included, such as ones that the assisted person might manually activate to call for immediate help in case of emergency. Motion sensors can be placed advantageously in frequented rooms, such as living room, bedroom, and kitchen. Biometric sensors may include weight, blood pressure, blood glucose, blood oxygen, blood thickness, and body temperature, among others. Other sensors now existing or not yet invented may be used. By way of non-limiting example, data can be obtained from so-call “smart appliances” and “smart houses” that have their own data collection and reporting capability. These sensor preferably will link to the system electronically to transmit readings, but they need not take readings automatically or continuously. The assisted-person interface 16 preferably includes a touch screen computer, though interactive voice response systems and other interface devices now in existence or not yet invented may be used. Preferable, the interface will take a form that is convenient and easy-to-use for the assisted person.

The caregiver interfaces 17 may be accessed from wherever it may be convenient for a caregiver, such as in the caregiver's place of residence or work, or through a mobile device carried by the caregiver. The caregiver interface 17 may be, by way of non-limiting example, a standard desktop computer, portable computer, personal digital assistant, cell phone or other interface device not yet invented that connects to the system 10 through fixed or mobile communication links. A single assisted person may be associated with multiple caregivers, and any particular caregiver may have multiple caregiver interfaces 17.

Vendor interfaces 18 may be accessed from the places of business of vendors, such as grocery stores, delivery services, taxi services, etc. Vendor interfaces 18 may take any form appropriate for the vendor to receive, acknowledge, and otherwise manage transactions for goods or services. They may be, for example, a fax machine, email account, desktop computer, point of sale terminal, mobile phone text channel, or any other channel now existing or not yet invented.

The computer server system 11 and database(s) 15 may be located substantially anywhere, provided that communication links are available to connect them to other parts of the system 10. It is contemplate that the server system 11 may be operated as part of a business with key elements hosted at a high-availability data center. Server system 11 may be centralized or decentralized, located in a common location or dispersed among different locations. A single server or collections of servers may support different assisted persons, vendors, caregivers, and/or combinations thereof.

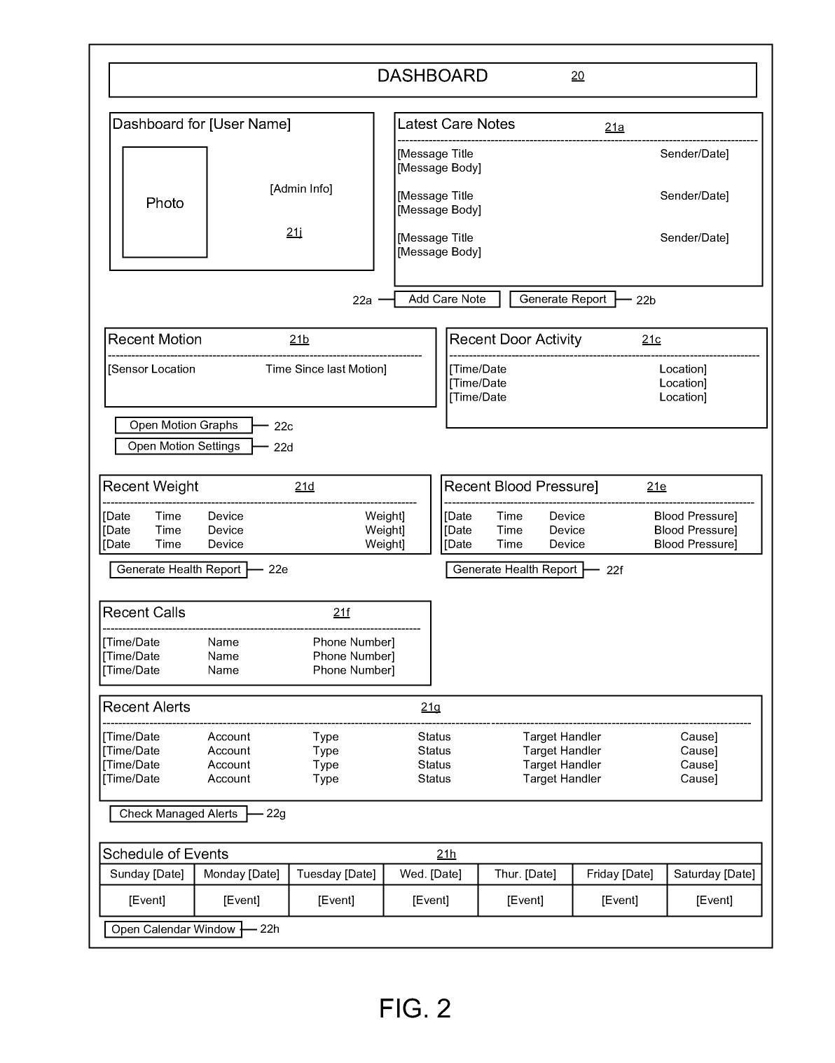

FIG. 2 illustrates one view 20 of many possible views that a caregiver can have through a caregiver interface. As discussed above in connection with FIG. 1, the system may include one or more databases. FIG. 2 illustrates a view that includes data selected data from one or more of these databases. It will be appreciated that many views of data are possible.

The view 20 of FIG. 2 includes a number of fields displaying data. A Care Notes field 21a displays messages entered by caregivers, which may be referred to as “Care Notes.” A caregiver has an ability to keep a log the caregiver's observations about the wellness status of the assisted person, in addition to other information. Care Notes may, for example, include information about the assisted person's subjective feelings (“I feel well today,” or “My arm hurts today”), the caregiver's independent observations (“Assisted person not eating”), administrative messages from one caregiver to another (“From AM nurse to PM nurse: assisted person's medication was changed—watch for possible side effects,”) or any other text entry that might be helpful or desirable. The Care Notes field 21a may display a note title, identity of the author, creation date, and message body. The Care Notes field 21a may display more or less information. A caregiver may “click” on a first button 22a to add a note, or “click” on a second button 22b to generate a report of notes.

A Recent Motion field 21b shows motion sensor data. The motion data field 21b may show a location for a sensor that last detected movement (e.g., “master bedroom”), and a period of time that has elapsed since the last motion was detected. The Recent Motion field 21b may display more or less information. A caregiver may click on a Graphs button 22c to generate a graphical view of motion or on a Settings button 22d to configure current or new sensors and rules related to the sensors. A Door Activity field 21c may show dates, times, and locations of doors whose status changed. These sensors give information about whether the assisted person is in or out of bed, in or out of the residence, opening a medicine cabinet to take medication or use toiletry supplies, opening the refrigerator to prepare a meal, etc.

Other fields 21d, 21e show other data, such as recent weight measurements and blood pressure readings respectively. This data gives information not only about the assisted person's wellness status, but also activity data about whether the assisted person is diligent in monitoring his/her own wellness status. A caregiver can view recent readings in the fields 21d, 21e or generate a report for either set of readings by clicking on a corresponding Report button 22e, 22f. Fields 21d, 21e may show date, time, identity of the measuring device, and measurement taken. More or less information may be shown.

A Calls field 21f shows a log of telephone calls. The assisted-person interface may provide telecommunications capability, and a view 20 such as this would allow a caregiver to monitor such activity. This field 21f may show date, time, name of caller, and phone number of caller. For example, the system may include a modem to which a telephone may be connected, and the system could maintain a log of calls based on Caller ID or other signaling data. More or less information may be shown.

An Alerts field 21g shows a log of alerts. The system can monitor sensor readings and send a message to a caregiver if sensor readings meet pre-defined criteria. For example, the assisted person's residence may be equipped with a pressure sensor in the bed. An alert can be set to send a message to a caregiver if the assisted person is not out of bed by 8:00 am, or if the assisted person is not in bed by 12:00 midnight. This field may show date of alert, time, account (which identifies the assisted person and associated caregivers), alert type, status, identity of the person who was responsible for handling the alert, and the cause (e.g., sensor(s) and/or condition) that triggered the alert. A Check Managed Alerts button 22g opens additional screens that let a caregiver acknowledge and review alerts. More or less information may be shown.

An Events field 21h shows a calendar of events for the assisted person. The assisted person may schedule appointments or other calendar items, such as a taxi pick-up. An Events field 21h preferably allows the caregiver to see the associated person's calendar, which might give context for other readings. For example, if the assisted person had scheduled a taxi at 9:00 for a doctor's appointment, a caregiver could check whether the assisted person was preparing for the event, such as by being out of bed (bed sensor), preparing breakfast (refrigerator sensor), grooming (medicine cabinet sensor), and preparing to leave (closing windows). This exemplary field 21h shows a one-week calendar, but the caregiver may get a more extensive view by clicking on an Open Calendar button 22h.

The view 20 may also provide an administrative field 21j with administrative information about the person whose data is on display, including a photograph of the assisted person. This can be especially helpful when a caregiver is responsible for multiple assisted persons. For example, if the caregiver is a nurse's assistant assigned to twenty or more assisted persons, the photos lets the nurse's assistant quickly and easily identify the person whose data is on display.

The view of FIG. 20, and other views described herein, are meant to be illustrative only and not limiting. In one embodiment, the assisted person computer 102 and Biometric Devices 104 of FIG. 1 may include components made by GrandCare Systems LLC, 2412 West Washington, West Bend, Wis. 53095. Exemplary components may include the Grandcare Trillium system, which includes a touch screen interface, sensors, communications components, and software to provide views of sensor data such as the view 20 of FIG. 2. Functions described above may be implemented with other system components. Additional or different views and fields may be provided. Data may be presented in a variety of different combinations and formats.

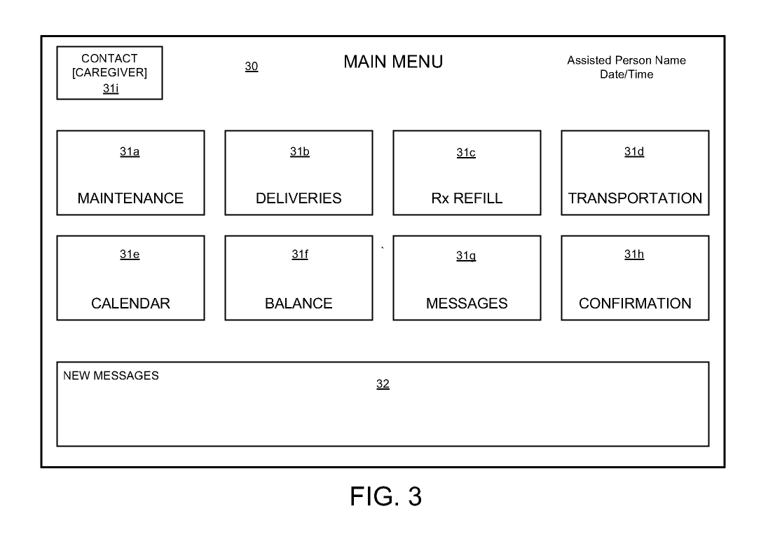

FIG. 3 illustrates one view 30 of many possible views that an assisted person could have through an assisted-person interface. The assisted person could reach this view after logging into the system by entering a Personal Identification Number. The physical device preferably is a touch screen. Major items are “buttons” 31a, 31b, 31c, 31d, 31e, 31f, 31g, 31h, 31i, which provide functions to help the assisted person with activities of daily living. The assisted person may touch a button to make a selection. In general, additional screens may appear with further selection choices upon touching any button.

Many buttons of this view 30 relate to the ordering of goods and services. This exemplary view 30 provides four categories: Maintenance 31a, general Deliveries 31b, Prescription Refills 31c, and Transportation 31d. A caregiver can control which, if any, of these button would be available to an assisted person. When available, these buttons 31a, 31b, 31c, 31d would activate processes for placing orders when touched by an assisted person, as will be discussed in further detail below. A Confirmation button 31h would open a view that summarizes pending transaction across the various categories. A Calendar button 31e would open a calendar display of appointments, such as taxi services ordered through the Transportation category 31d. A Balance button 31f would open a view with information and options relating to funds available for transactions, which will be discussed in more detail below.

Other buttons generally relate to communications. A “Contact” button 31i preferably is a one-touch button (no further function screens) that sends an immediate message to a designated caregiver or other contact person indicating that the assisted person wants to communicate. The designated caregiver might respond by placing a phone call to the assisted person, sending a text, opening a text, voice, or video chat session, or even appearing in person, depending on the nature of the relationship between the assisted person and the caregiver. A New Message field 32 displays recent electronic messages for the assisted person, such as whether an order for goods has been accepted or rejected. A Messages button 31g would open additional views relating to older electronic messages.

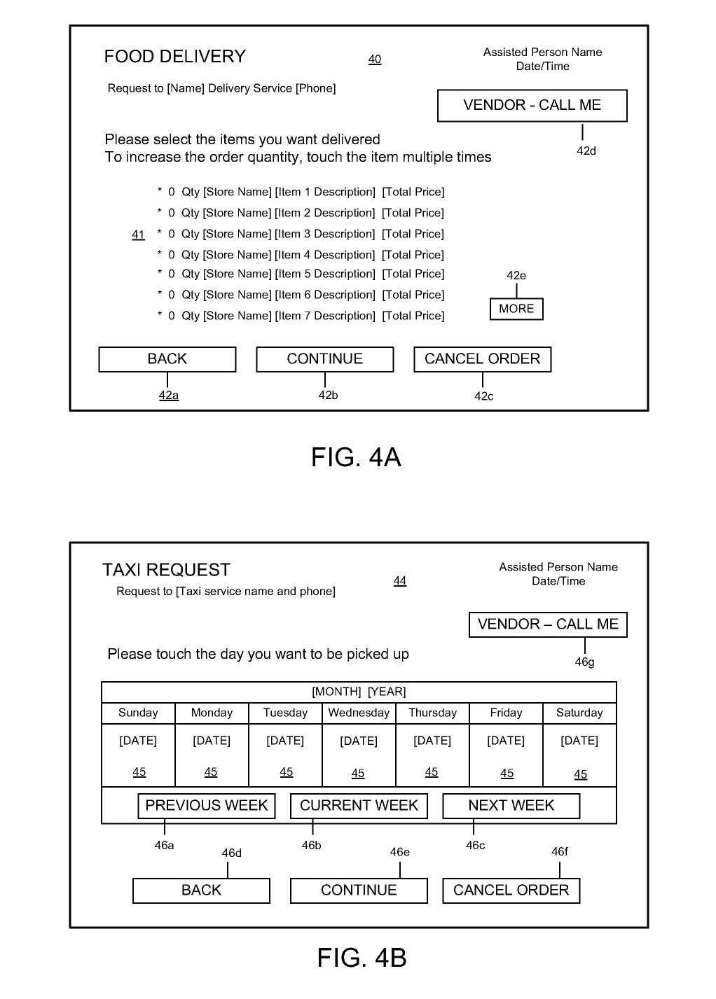

FIG. 4A illustrates one view 40 of many possible views that an assisted person could have through an assisted-person interface that exemplifies a process for ordering groceries. After touching the Deliveries button (FIG. 3, item 31b), one or more intermediate views may appear (not shown) that give the assisted person one or more choices of categories from which to order, such as grocery store items, restaurant take out items, laundry services, medical supplies, etc. The view 40 of FIG. 4A would appear after selecting a category for groceries. It displays a menu of items 41 which the assisted person may order. The caregiver may pre-select items to be made available in this view, as will be discussed further below. For each item 41, the view 40 may show an item description, the name of the store providing the item, and a unit cost for the item. Selecting an item multiple times could increase the ordered quantity and could cause the view 40 to update. The assisted person may touch any of several order-related navigation buttons. A Cancel Order button 42c terminates the transaction and returns the display to the Main Menu view of FIG. 3. A Back button 42a returns to a prior screen to select another category of items to order. A More button 42e takes the assisted person to new screens of items that can be ordered. Additional screens may be provided to show additional items, and additional buttons may be provided to navigate those screens. If the assisted person wants to communicate directly with the vendor, such as to ask questions about an item, a Vendor-Call-Me button 42d would send a message to the vendor. The vendor then could call the assisted person directly. A Continue button 42b proceeds to next steps of the ordering process, which may include a display that summarizes of all items ordered, options to select delivery times, and, options to confirm the order. Once an assisted person confirms an order, the system would send the order to the selected vendor. (Additional steps may take place prior to fulfillment, as will be discussed further below.) The assisted person preferably would receive a message verifying the order status as, e.g., accepted, rejected, awaiting confirmation, etc. The assisted person would be able to see the message in the New Messages field (FIG. 3, item 32) and see additional information about the order through the Confirmation option (FIG. 3, item 31h).

FIG. 4B is one view 44 of many possible views that an assisted person may have through an assisted-person interface that exemplifies a process for ordering a transportation service, an example of which might be a taxi. After pressing the Transportation button (FIG. 3, item 31d), an intermediate view may appear (not shown) that gives the assisted person a choice of transportation services, such as a choice of several taxi companies. The view 44 of FIG. 4B is for one taxi company. It displays a calendar of days 45. The assisted person may select a day for the taxi by pressing the appropriate day 45 on the touch screen. Calendar navigation buttons 46a, 46b, 46c let the assisted person scroll among different weeks. The assisted person may press any of several order-related navigation buttons 46d, 46e, 46f. A Cancel Order button 46f terminates the transaction and returns the display to the Main Menu view of FIG. 3. A Back button 46d returns the display to a prior screen to select other categories of items to order or, if there was no intermediate screen, to the Main Menu view of FIG. 3. If the assisted person wants to communicate directly with the vendor, a Vendor-Call-Me button 46g sends a message to the vendor.

A Continue button 46e proceeds to next steps of the ordering process. From there, the assisted person may select a pick-up time and destination, and confirm the order. The caregiver may pre-select destinations so that they appear as selectable destination in a view, similar to the way the caregiver may select the menu of grocery options. Once confirmed, the order will be sent to the selected vendor, and messages about the order may be sent to the caregiver and/or other designated persons. Additional steps may take place prior to fulfillment, as will be discussed further below. The assisted person preferably receives a message verifying the order status as accepted, rejected, awaiting confirmation, etc.

Ordering of other goods and services may proceed in an analogous manner as described above for groceries and taxi services. The exact sequence of screens and choices may be tailored to the particular goods and services. It is preferred that the process be made as simple as possible for the assisted person, since people needing assistance may at times have difficulty navigating more complex operations.

A philosophy of the ordering process is that a caregiver may work with the assisted person to configure the system to give the assisted person a pre-set choice of options. The caregiver and the assisted person may work together to strike a balance between variety and simplicity that is most appropriate to the assisted person's preferences and circumstances. For example, a particular grocery store may offer thousands of items for sale, but the caregiver and assisted person may select a limited set of, for example, the two hundred items that the assisted person most frequently uses and orders. (The system need not place a limit on the number of items.) In this way, the assisted person may conveniently order most of supplies for daily living without unnecessary complication. Where the system is used with multiple assisted persons, each caregiver may customize the choices for each assisted person under that caregiver's care.

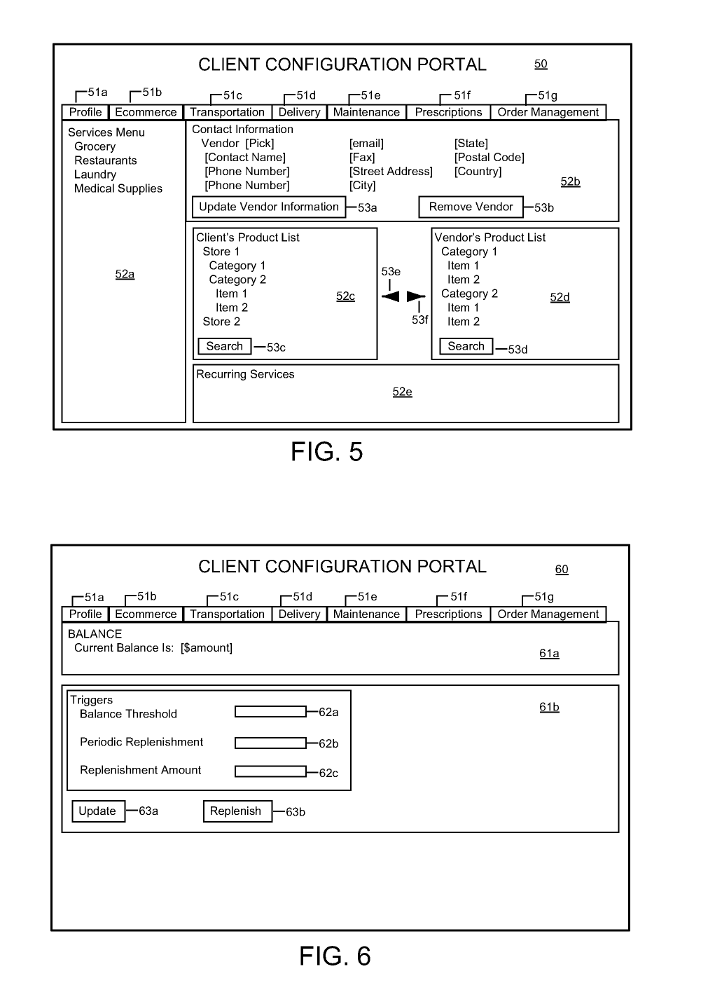

FIG. 5 illustrates one view 50 of many views that a caregiver could have through a caregiver interface that exemplifies a process of configuring the system for a particular assisted person. The caregiver could access this or a similar view, and other views, using caregiver-specific authentication information, such as a password. The assisted person preferably would not be authorized to access these and related configuration views.

The view 50 of FIG. 5 allows the caregiver to select grocery items that would appear to the assisted person in the view of FIG. 4A. The view 50 includes a series of tabs. The caregiver would select a particular assisted person for whom customization will be made with selection options under the Profile tab 51a.

Many of the tabs correspond to categories of goods and services to which an assisted person may have access. FIG. 5 shows a view for the Delivery tab 51d, which corresponds to the assisted person's Deliveries option 31b of FIG. 3. The view 50 of FIG. 5 includes a field 52a that gives the caregiver a choice of specific groups of services to configure, such as Grocery, Restaurants (for take out orders), Laundry services and Medical Supplies. These groupings are merely exemplary. Other groupings may be used. FIG. 5 shows a view corresponding to the assisted person's Food Delivery option of FIG. 4A. The view 50 of FIG. 5 includes a Contact field 52b for adding or removing food vendors from which the assisted person may order groceries. The system may be administered by an operator, such as an assisted living facility, nursing facility or other service company that will maintain the system for use by multiple assisted persons. The operator may pre-qualify a number of grocery stores and other vendors to be available through the system. An individual caregiver may select one or more of the pre-qualified vendors to be available to a particular assisted person according to the assisted person's preferences and circumstances. Field 52b lets the caregiver choose vendors that will appear as choices for the assisted person through the assisted-person interface. The caregiver may pick a vendor from a pick list and then enter or remove the vendor by making selections with an Update Vendor button 53a or Remove Vendor button 53b.

The view 50 includes fields 52c, 52d that allow a caregiver to pick individual items to be visible to the assisted person, such as through the view 40 of FIG. 4A. A “Vendor's Product List” field 52d displays a list of all products available from the vendor selected in field 52b. A “Client's Product List” field 52c displays a list of all products that the system will make visible to the assisted person. Using a cursor control (not shown) and an Add button 53e, the caregiver may select items from the vendor list 52d and add them to the client list 52c. The caregiver may similarly select items in the client list 52 and remove them with a Remove button 53f. Search buttons 53c, 53d let the caregiver search for specific items in either list 52c, 52d. The view 50 also includes a recurring services field 52e. Through this field 52e, a caregiver may configure the system to order certain goods or services on a recurring basis by defining a start date, and end date, a frequency, and additional instructions. For example, the caregiver may arrange for a weekly delivery of milk, bread, cheese, and certain vegetables.

A caregiver may similarly configure other aspects of the system as it would be experienced by an assisted person. Other tabs for Transportation 51c, Maintenance 51e, and Prescriptions 51f allow the caregiver to customize the assisted person's options for corresponding views through the assisted-person interface. A tab for Order Management 51g lets a caregiver see the orders placed by an assisted person, and the caregiver may reject, modify or create new orders.

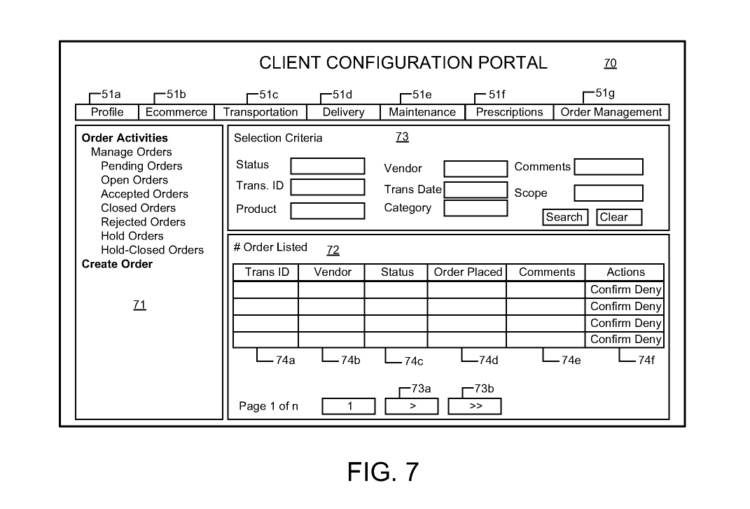

FIG. 6 illustrates one view 60 of many possible views that caregiver could have through a caregiver interface to help the assisted person with financial management. This view 60 could appear after the caregiver selects the Ecommerce tab 51b of FIG. 5. This view 60 includes a Balance field 61a that displays the assisted person's current financial account balance.

This view 60 also includes a Trigger field 61b that lets a caregiver (or other authorized person) replenish the assisted person's financial account. For purposes of this discussion, it will be assumed that the authorized person is the caregiver, though another person may be authorized. The caregiver may set a balance threshold 62a. The system will send a notification to the caregiver or other designated person when the assisted person's account falls below this threshold. The caregiver also may set a time period 62b and financial amount 62c for automatic replenishment. The system will automatically transfer the specified amount of funds to the assisted person's account from an external financial account after the specified time. The caregiver may enter threshold, replenishment period, and replenishment amount in their respective fields 62a, 62b, 62c and update the system parameters using an Update button 63a. The caregiver also my cause a one-time manual replenishment by entering an amount 62c and using the Replenish button 63b.

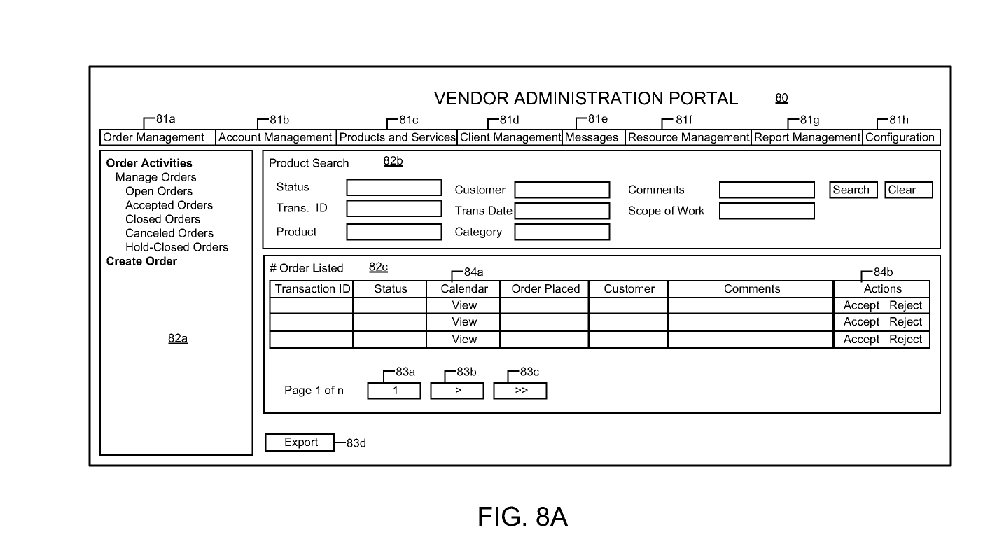

FIG. 7 illustrates one view 70 of many possible views that caregiver could have through a caregiver interface to help the assisted person with order management. This view 70 could appear after the caregiver selects the Order Management tab 51g of FIG. 5. This view 70 includes an Order Activities field 71 that displays a set of options for viewing an assisted person's orders, such as pending orders, open orders, accepted orders, closed orders, rejected orders, open orders on hold, and closed held orders. The selected group of orders would appear in an Order Listed field 72. Navigation buttons 73a, 73b allow a caregiver to page through multiple pages of orders. Alternately, the caregiver could search for a particular order or group of orders using a search field 73. Rows in the Orders Listed field 72 correspond to individual orders. For each order, the view could displays a Transaction ID 74a, Vendor name 74b, Status of the order 74c (e.g., open, closed, on hold, . . . ), date when the order was placed 74d, and comments that might have been made 74e.

This view 70 gives a caregiver several ways to affect an order placed by an assisted person. A caregiver may confirm or deny an order by clicking in an “Actions” column 74f for the order. A caregiver may edit an order by clicking on a transaction ID number 74a for the order, at which point another view may appear with order details and edit options. A caregiver also may place a new order for the assisted person by clicking on a Create Order option in the Order Activities field 71.

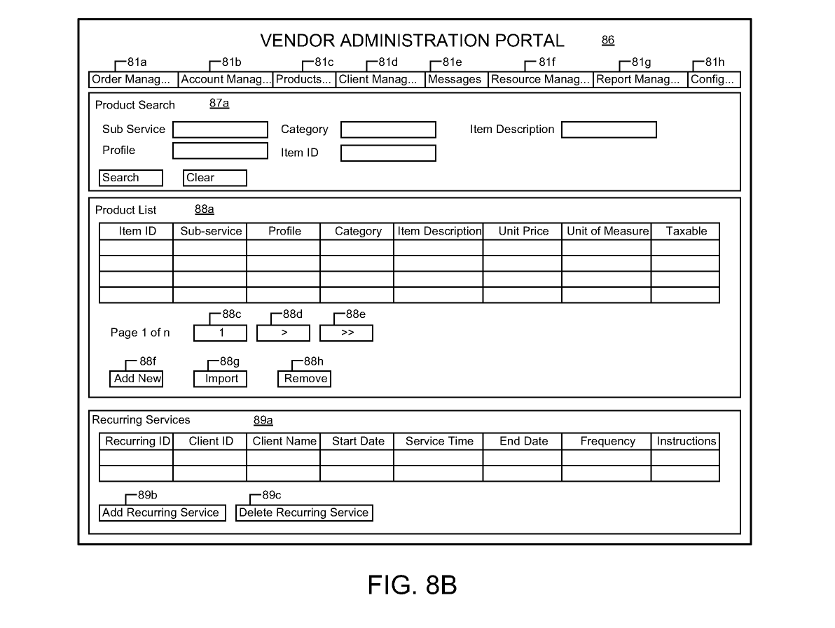

FIG. 8A illustrates one view 80 of many possible views that a vendor could have through a vendor interface relating to order management. A vendor could access this or a similar view, and other views, using vendor-specific authentication information, such as a password. The assisted person would not ordinarily be authorized to access this and related vendor views. The view 80 of FIG. 8A includes a number of tabs 81a, 81b, 81c, 81d, 81e, 81f, 81g, 81h which, upon selection, opens additional fields. An Account Management tab 81b gives a vendor views to update administrative information, such as the vendor's address, contact person name, phone number, etc. A Client Management tab 81d provides administrative information to the vendor about assisted persons, including but not limited to telephone number and/or other contact information. A Messages tab 81e allows a vendor to view messages received through the system and to generate messages to be sent to directly to specific assisted persons or other system users. A Resource Management tab 81f allows a vendor to view, add or edit human resource data for human resources of the vendor that can be assigned to work on client orders. A report Management tab 81g gives a vendor capability to generate views from the database about orders. Vendors may sort orders according to a variety of criteria, generate reports, perform analysis on trends, and ultimately select merchandise that best serves the needs of assisted persons. A Configuration tab 81h allows a vendor to set certain administrative parameters. For example, for a recurring order, the system will generate an order at a pre-designated time period prior to the scheduled delivery. A vendor may adjust this pre-designated time period as an administrative parameter under the Configuration tab 81h.

The view 80 of FIG. 8A illustrates additional fields 82a, 82b, 82c that could be displayed upon selection of an Order Management tab 81a. These additional fields 82a, 82b, 82c allow a vendor to view, accept, reject, and otherwise manage orders placed by other users of the system, and to create new orders for an assisted person. An Order Activities field 82a displays a set of options for viewing groups of orders, such as open orders, accepted orders, closed orders, canceled orders, and held-closed orders. The selected group of orders would appear in an Order Listed field 82c. Navigation buttons 83a, 83b, 83c allow a vendor to page through multiple pages of orders. Alternately, the vendor could search for a particular order or group of orders using a search field 82b. Rows in the Orders Listed field 82c correspond to individual orders. For each order, the view could display a transaction ID, status of the order (e.g., open, closed, cancelled, . . . ), date when the order was placed, customer name, and comments that might have been made. A Calendar field 84a allows a vendor to see an expanded view, such as a pop-up window, with a calendar of an assisted person who placed the particular order. Preferably, the calendar would show orders from all vendors, though any particular vendor would not be able to see details about orders that the assisted person may have placed with other vendors. An Actions field 84b lets a vendor accept or reject an order. An Export button 83d allows a vendor to export a list of orders. A vendor also may place a new order for the assisted person by clicking on a Create Order option in the Order Activities field 82a. This may be convenient if an assisted person has pressed on a “Vendor Call Me” button (e.g., FIG. 4A or FIG. 4b) and the vendor has had a telephonic conversation with an assisted person.

FIG. 8B illustrates one view 86 of many possible views that a vendor could have through a vendor interface relating to product offerings. The view 86 of FIG. 8B illustrates additional fields 87a, 88a, 89a that could be displayed upon selection of the Products tab 81c. These additional fields 87a, 88a, 89a allow a vendor to configure the system to make specific products and services available to assisted persons who are users of the system. Said another way, this view lets a vendor select the products that an assisted person could see and order. A product list field 88a allows a vendor to add items to the system along with associated data, such as an Item ID number, a Sub-service name (e.g., “Grocery”), a Supplier name (by identifying a vendor Profile name), a Category (e.g., “Produce”), an Item Description, a Unit Price, a Unit of Measure for the Unit Price, and an indication whether the item is subject to sales tax. Navigation buttons 88c, 88d, 88e allow the vendor to page through multiple views of products. Selection buttons 88f, 88h allow the vendor to add or remove items. An Import button 88g lets a vendor import a file of items. A Product Search field 87a lets a vendor search for existing products, which is useful for updating data for individual items. A Recurring Services field 89a allows a vendor to offer recurring services and to enter information unique to such services, such as an ID number for the service, an ID number for a client (assisted person) receiving the service, a client (assisted person) name, a start date, a service time, an end date, a frequency, and special instructions. Add and Remove buttons 89b, 89c let a vendor manage offerings or recurring services.

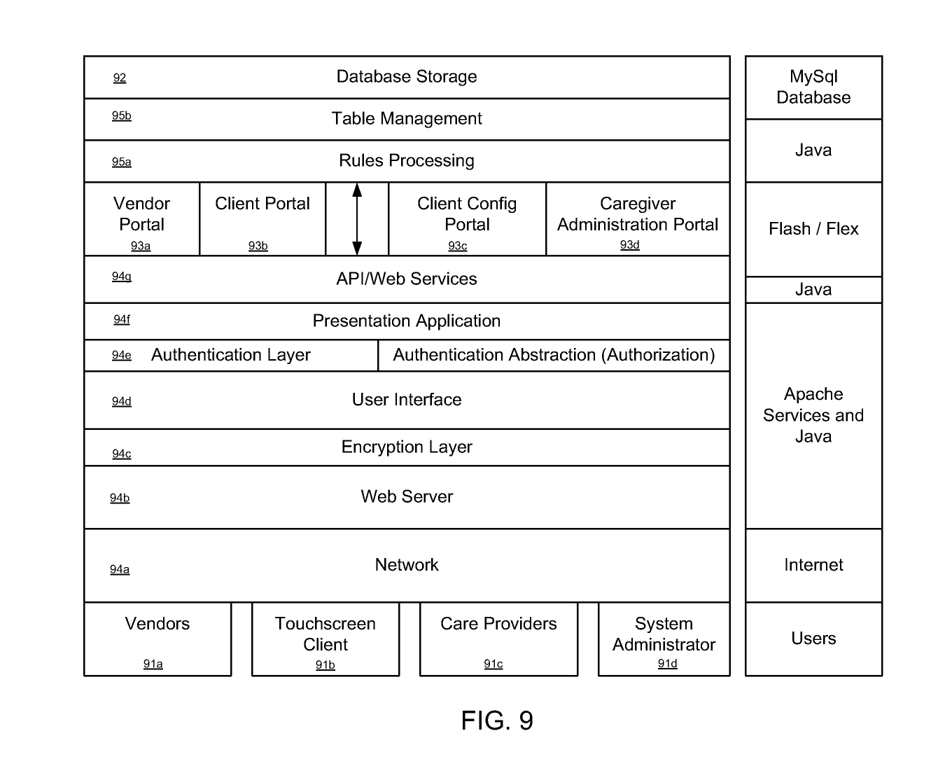

FIG. 9 illustrates an exemplary software architecture for an embodiment of a living assistance system with emphasis on a server system. Boxes labeled Vendors 91a, Touchscreen Client 91b, Care Providers 91c, and System Administrator 91d represent users of the system. A box labeled Database Storage 92 represents a database containing data used in the system. Boxes labeled Vendor Portal 93a, Client Portal 93b, Client Configuration Portal 93c, and Caregiver Administrative Portal 93d represent processes that manage user experiences, such as views illustrated above (and others not shown), and act as interfaces for accomplishing functionality described above and below (and others not shown).

By way of generic example, when an assisted person manipulates a touchscreen of an assisted-person interface described above in connection with FIG. 3, a Touchscreen Client 91b communicates with the Client portal 93b. That connection passes through a number of communication layers, including a network layer 94a (which may be the Internet or other network), a Web Server 94b, an Encryption layer 94c, a User Interface layer 94d, an Authentication/authorization layer 94e, a presentation layer 94f, and an Application Program Interface (API) layer 94g. A Table Management layer 95b provides a number of database functions, such as managing temporary data before updating Database Storage 92. Other assisted persons connect similarly through their respective Touchscreen Clients 91b to the Client portal 93b, and multiple Vendors 91a each may connect through their respective interfaces with the Vendor portal 93a. Care Providers 91c each may connect through a Client Configuration Portal 93c, through a Caregiver Administration portal 93d.

Implementation of systems with layered communications are generally understood, but several aspects of a preferred system will be noted here. The Authentication Layer 94e identifies the identity of each user, typically by pin number or password. Each user's authorized capabilities may vary, and authentication lets the system give an individual user greater or lesser capability according to the user's identity. For example, a caregiver may be able to alter the assisted person's pick list of prescriptions that can be ordered, but a vendor may not. A preferred authentication layer includes a means of securely authenticating a client device, such as a touchscreen, which is distinct from authenticating the identity of the user. The system can authorize different individuals to have access to different capabilities and information depending on their identities. Individuals (that is, people as distinct from devices) may be assigned different “roles” which govern their respective levels of access and capabilities. It is possible to designate a single person as both a Vendor and a Caregiver if, for example, a vendor of the system also had an elderly parent who coincidentally was an assisted person. The Application Program Interface 94g implements a variety of processes that may be called to perform functions discussed herein, especially those that involve communication with or through multiple portals.

The Rules Processing layer 95a implements much of the specific decision-making functionality for helping the assisted person with living activities. By way of example, and without limitation, the system may be configured with an option so that a caregiver must authorize an assisted person's orders. The Rules Processing layer 95a would implement such conditional tests. The API/Web Services layer 94g acts as a communication interface and coordinates certain processes that do not involve conditional decision-making.

In one embodiment of an assisted living system3, the Web Server 94b, Encryption Layer 94c, User Interface 94d, Authentication/Authorization Layer 94e, and Presentation Layer 94f may be implemented with Apache™ Services and JAVA™. An Application Program Interface/Web Services layer 94g may be implemented with a combination of Java™ and Flash & Flex™. Portals 93a, 93b, 93c, 93d may be implemented with Adobe Flash & Flex™, though it will be appreciated that a wide variety of other implementations may be used, including without limitation portals of a client/server architecture, and other interfaces capable of maintaining communications and managing user experiences. Rules Processing may be implemented in Java™. The Database Storage 92 may be implemented with MySql™. Table management may be implemented with a combination of MySqul™ and Java™. Other implementations may be used.

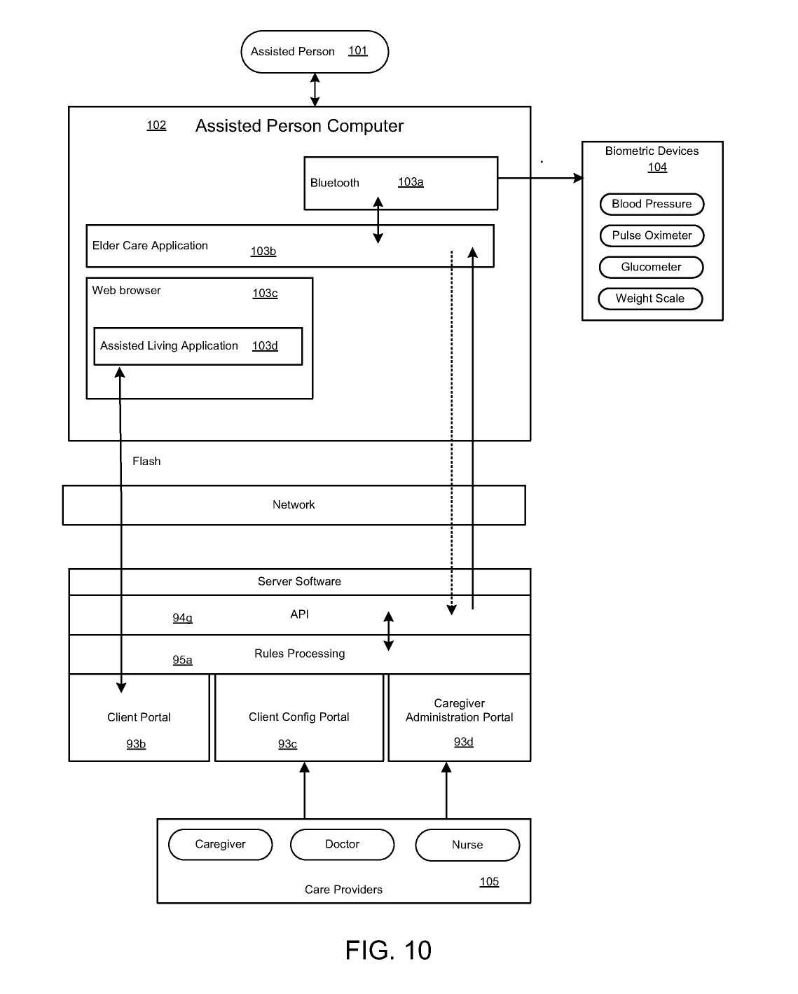

FIG. 10 illustrates an exemplary software architecture for an embodiment of a living assistance system with emphasis on communications. An assisted person 101 interacts with a computer 102, preferably through a touch screen. The computer 102 may include supporting software elements, such as a touchscreen interface, operating system, hardware interfaces, software drivers, etc. A number of authentication functions may be included to assure that the system identifies communicating entities, such as by providing encryption capability, processing user identification numbers, managing secure tokens, and identity management. The operating system may be a GCLinux operating, though other operating systems may be used. The computer 102 also receives data from biometric devices 104, such as blood pressure, blood oxygen, blood sugar, weight, body temperature, etc., preferably through a wireless BlueTooth interface 103m. An Elder Care Application 103g manages biometric data and may perform other functions.

When an assisted person 101 has been authenticated, the computer 102 communicates with the Client Portal 93b (see also FIG. 9). The Client Portal 93b downloads a Flash application 103k to a browser 103e of the assisted person's computer 102. The Flash application 103k may be a thin client that manages the views presented to the assisted person and provides other functions of the kind described herein.

In one embodiment, the assisted person computer 102 and Biometric Devices 104 may include components of the Grandcare Trillium system, which includes a touch screen interface, sensors, communications components, and software. The GrandCare Trillium System provides communication, cognition and ADL monitoring features. Those components or other components also may be connected to provide a continuous display of information, such as weather updates and news. Family of an assisted person may send pictures, messages, reminders, calendar appointments, audio clips, etc. Users may search the Internet, play trivia and card games, listen to music, view caller ID, review an in-depth calendar of events, interact with video conferencing, and check email, among other functions. Caregivers can activate activity and wellness monitoring and alerts. GrandCare Kiosk™, HomeBase™ and Como™ computers also may be used.

A use scenario will be described below with reference to FIG. 10 to illustrate exemplary operation of the system. This scenario is not intended to be exhaustive, defining, or otherwise limiting.

In one possible use of the system, a care provider 105 may log onto the server system using a unique identifier for the care provider 105, which should be different from authenticating information for the assisted person 101. The care provider may be, for example, an adult child of an elderly parent who is the assisted person. The care provider 105 also may be a nurse or other professional caregiver. This example will refer to a caregiver. Because the assisted person may be living independently, the caregiver 105 might not have seen the assisted person for a period of time. The caregiver 105 could view recent biometric data like that of FIG. 2A. The caregiver might notice that assisted person's blood pressure has become elevated. The caregiver could then log into the server system through the Client Configuration portal 93c and access views like that shown in FIG. 5. The caregiver 105 could remove items from the list of foods that the system makes available to the assisted person to order, such as removing certain high-salt items. On another visit to the assisted person 101 at a later date, the caregiver might again check the assisted person's biometric data and see that the assisted person's blood pressure has returned to a lower level. The caregiver could then log back into the server system to a view like that shown in FIG. 5 and restore the previously-removed items to the assisted person's menu of grocery items available for order.

In another embodiment of an assisted living system, rules may be included to adjust the assisted person's options automatically according to biometric readings. The architecture described herein could allow the server API 94g to access biometric data from the Elder Care Application 103g. The server API 94g then could access rules from the server Rules Processing application 95a. A caregiver could set rules for adding or removing items from the available menus of goods and services that may be ordered as a function of biometric readings. For example, if a biometric reading shows that the assisted person 101 has a fever, the server API 94g could initiate a message to the caregiver about the assisted person's wellness status. The server API 94g also could query a calendar and/or pending orders for the assisted person 101. If the assisted person 101 had scheduled a taxi on that particular day, the server API 94g could initiate a message to the assisted person 101 asking whether the taxi should be cancelled. If appropriate, the server API 94g could initiate communications to the Taxi company cancelling the taxi for that day.

The scenario above is merely an example to illustrate flexibility of the architecture. Implementations may give caregivers a variety of capabilities, and each caregiver may configure the system as appropriate for an assisted person.

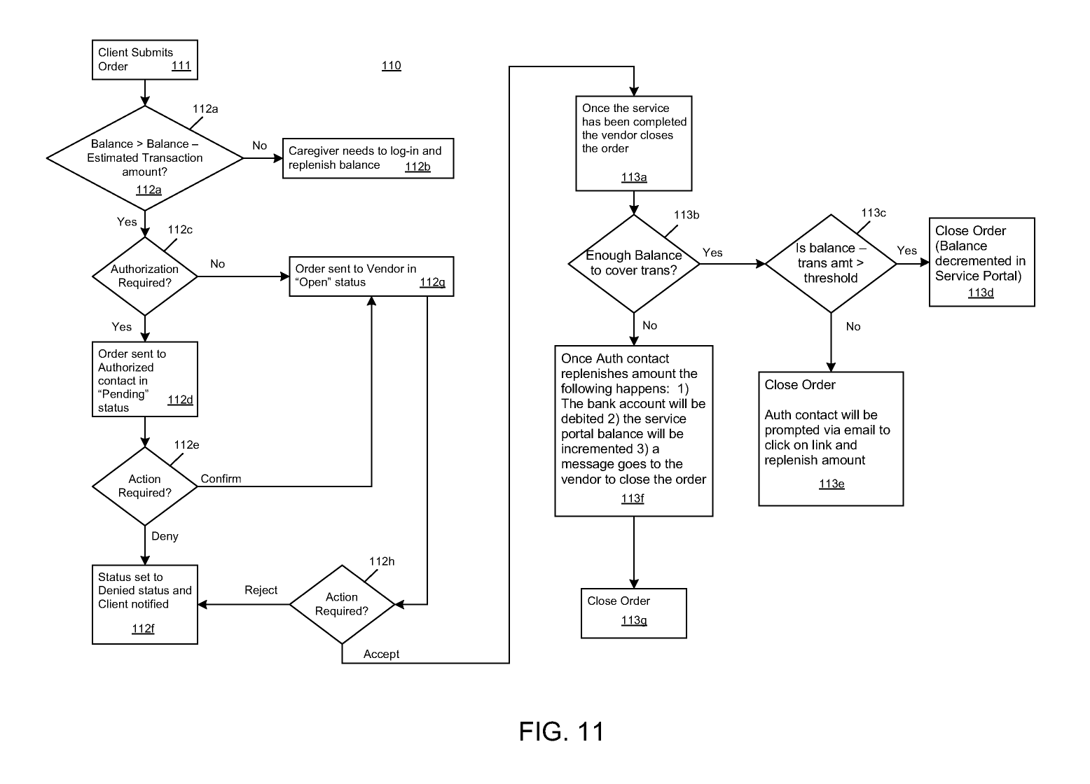

FIG. 11 illustrates an exemplary process 110 for an order creation process. This example is one of many possible examples and is provided to illuminate certain general principles without limiting the scope of the invention. Other processes may be used.

Prior to beginning the process 110 of FIG. 11, a system administrator would have enabled one or more vendors to offer products or services through the system. A caregiver would have selected one or more vendors to be displayed to the assisted person, such as by logging into the client configuration portal (FIG. 9, items 91c and 93c) and configuring the system to authorize one or more vendors using a view such as the one illustrated in FIG. 5. The caregiver also would have configured the system to display one or more of each vendor's products specifically for the assisted person. The assisted person then would have logged onto the system through the touchscreen and client portal (FIG. 9, items 91b and 93b) and selected one or more products using a view similar to the one illustrated in FIG. 4A. The assisted person's computer would send a message to the server to initiate the order process. In one embodiment, the touchscreen client (FIG. 9, item 91b) would send a message for initiating the order process through the system to the server API (FIG. 9, item 94g). The server API 94g then would coordinate communications to other system elements, such as Database Storage (FIG. 9, item 92) and Rules Processing (FIG. 9, item 95a) as required to initiate the order. In the description that follows, the API may initiate decisions by passing messages to the Rules Processing layer (FIG. 9, item 95a). The API may obtain data by sending queries to Database Storage (FIG. 9, item 92).

The process 110 begins upon receipt at the server API (FIG. 9, item 94g) with a message 111 that identifies the assisted person and items to be ordered. The process 110 performs a check 112a to determine whether the assisted person's account balance is enough to cover the order. If not, the process 110 initiates a message 112b to the caregiver that the caregiver should replenish the assisted person's account. The system may place the order on hold in a “pending” status while waiting for account replenishment.

If the assisted person's account is sufficient to cover the order, the process 110 performs a check 112c to determine whether a designated person, such as a caregiver, needs to authorize the transaction. If so, the process 110 initiates a communication 112d to the designated party, and the system holds the order internally in a “pending” status. The communication 112d to the third party may be by any means, such as email, text, pre-recorded telephone announcement, or others not yet invented. If the designated third party affirmatively rejects (denies) the transaction or has not authorized the transaction within a predetermined period of time, the process 110 may make a decision 112e to deny the transaction. The process 110 then would send messages 112f that the order has been denied to designated parties, such as the assisted person, the caregiver, and/or other designated contacts. The process 110 also sets the internal status of the order to “rejected.”

If the designated person authorizes the transaction, or if at check 112c authorization was not required, the process 110 sends a communication 112g to the vendor with the order. If the vendor rejects the order, the process 110 makes a decision 112h to reject the order internally, sets the order status to “rejected,” and sends communications 112f that the order has been rejected. If the vendor accepts, time will pass while the vendor fulfills the order.

After order fulfillment, the process 110 may resume when the vendor submits an invoice or otherwise presents a request 113a to close the order. The process 110 performs a check 113b to determine whether the assisted person's balance is sufficient to cover the transaction. If so, the process 110 performs a further check 113c to determine whether the post-closing balance would be above a balance notification threshold for the assisted person's account. If the post-close balance would be greater than the notification threshold, the process 110 initiates a series of actions 113d to close the order, such as making payment, updating order status, notifying the vendor, etc. If at check 113c the post-close balance would be below the notification threshold, the process 110 closes the order and initiates a series of actions to replenish the assisted person's account. In one embodiment, the process 110 initiates a message 113e to an authorized contact person to replenish the account. The contact may be the caregiver or another authorized person. The authorized contact person may replenish the account as described above in connection with FIG. 6. The replenishment process would include debiting an external financial account associated with the assisted person (such as a credit card, checking account, or Pay-Pal™ account), updating the assisted person's internal account balance, etc. If at check 113b the assisted person's balance is not enough to cover the transaction, the process 110 initiates a series of steps to replenish the assisted person's account without settling the transaction. In this case, the process 110 closes the order 113g after account replenishment. The process 110 closes the order internally by updating status, debiting the assisted person's account, crediting the vendor's account, notifying the vendor, etc.

The process described above is meant to be illustrative but not limiting to the scope of the invention. The ordering process may be different from that described above, and the ordering process may be adapted according to the nature of goods or services being ordered.

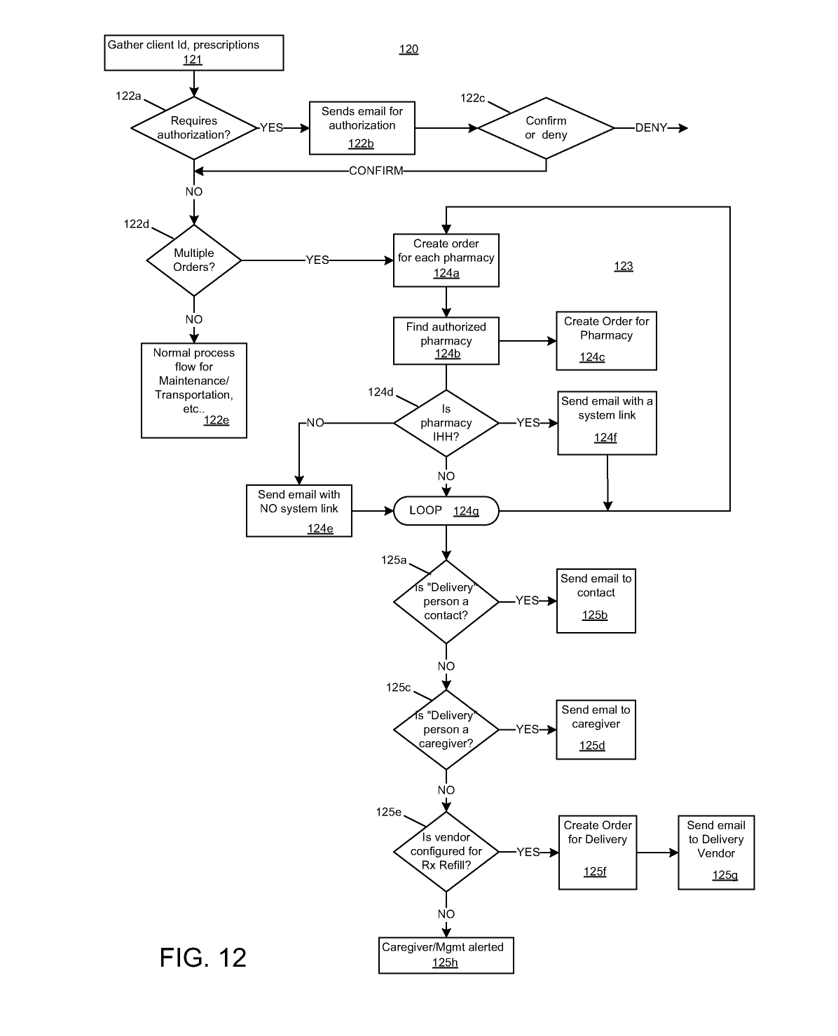

FIG. 12 illustrates an exemplary variation on an order process 120 that may be used when an assisted person orders a refill of a prescription. The process 120 of FIG. 12 begins upon receipt at the server API with a message 121 from the assisted person's computer identifying the assisted person (“clientid”) and one or more prescriptions being ordered (“prescriptions”). The process 120 performs a check 122a to determine whether a physician must authorize the refill. If authorization is required, the server API (FIG. 9, item 94g) would initiate a message 122b to a designated party to confirm or otherwise authorize the transaction. At a decision step 122c, the system would deny the transaction if the third party either affirmatively rejected the transaction or if a predetermined period of time passed without confirmation. A denial would result in other actions, such as sending a message to the assisted person stating that the transaction was denied, logging the transaction internally as a rejected order, etc. If the third party confirms the transaction, or if at check 122a authorization was not required, the process 120 would proceed to another test 122d to determine whether the assisted person's transaction requires more than one order, such as ordering from two different vendors. If only a single order, the process 120 would proceed with the order submission process 122e described above in connection with FIG. 11.

If multiple orders are required, the process 120 would perform a number of steps shown generally at 123 for each order. The process 120 would open an internal order 124a with attendant entries to the database (FIG. 9, item 92). The process 120 would perform a query 124b to identify a pharmacy that has been authorized for the particular assisted person. The process 120 would create a vendor order 124c to be communicated to the pharmacy. That system may then process that order as described above in connection with FIG. 11. The process 120 additionally would perform a check 124d to determine whether the pharmacy is an authorized vendor of the system (an “IHH” pharmacy). If so, the process 120 would initiate an email 124f to the pharmacy with a system link that lets the vendor view and manage the order. If not, the process 120 would initiate an email 124e or other communication to the vendor without a system link. In either event, the process 120 would perform a control step 124g to repeat the loop of steps 123 for each pharmacy.

Upon completion of the loop 123, the process 120 would perform a query 125a to determine whether a “contact” person has been set to receive delivery of the prescription. A “contact” person here is a person who has been pre-configured in the system as someone to contact on matters concerning the assisted person. The contact may or may not be the same as a caregiver. (For example, the designated caregiver may be a nurses assistant, while the contact person may be an adult child of the assisted person.) If so, the process 120 would initiate an email or other communication 125b to the contact person giving notice to expect a delivery. If not, the process 120 would perform a query 125c to determine whether a caregiver has been set to receive delivery of the prescription. If so, the process 120 would initiate an email or other communication 125d to the caregiver giving notice to expect a delivery. If not, the process 120 would perform a query 125e to determine whether a delivery service has been configured to handle deliveries from the pharmacy to the designated delivery recipient. If so, the process 120 would create an additional order 125f for the delivery service and initiate an email or other communication 125g to the delivery service with the order. The process 120 would generate an error message 125h if no delivery vendor has been set for the pharmacy and delivery recipient.

The various elements of the embodiment herein are preferably implemented on computer software operating in conjunction with either general purpose or specific purpose electronic computer hardware. Various described functions and/or processing could be implemented at the server system 11 and communicated to the interfaces, or occur at the interface platforms and be reported to the server system 11. One implementation is consistent with an Internet environment, in which the various views and corresponding interfaces are web pages that appear on a users computer.

The embodiments described above are intended to be illustrative but not limiting. Various modifications may be made without departing from the scope of the invention. The breadth and scope of the invention should not be limited by the description above, but should be defined only in accordance with the following claims and their equivalents.

What is claim is:

1. A system for a person receiving assistance with living activities, said system comprising:
(A) a computer system providing capability
(i) to provide information on an assisted person's living activities, and
(ii) to manage elements of commercial transactions between the assisted person and vendors;
(B) at least one portal for an assisted person, said assisted-person portal providing capability for the assisted person to initiate commercial transactions with vendors; and
(C) at least one portal for a care provider, said care-provider portal providing capability for the care provider
(i) to access information about the assisted person's living activities, and
(ii) to manage transactions initiated by the assisted person.

2. A system as in claim 1 wherein information on an assisted person's living activities includes data on an assisted person's instrumental activities of daily living.

3. A system as in claim 1 wherein information on an assisted person's living activities includes data from sensors of an assisted person's movement.

4. A system as in claim 1 wherein information on an assisted person's living activities includes data about an assisted person's activities to monitor biometric status.

5. A system as in claim 1 wherein information on an assisted person's living activities includes biometric data about the assisted person.

6. A system as in claim 1 wherein the care provider is a person from the set of: a nurse, a nurses assistant, and an agent of an assisted living facility providing care for the assisted person.

7. A system as in claim 1 providing capability for multiple care providers to provide living activity information about the assisted person.

8. A system as in claim 1 wherein the care provider may limit the assisted person's choices of transactions to a pre-determined set of products.

9. A system as in claim 1 wherein the care provider may limit the assisted person's choices of transactions to a pre-determined set of vendors.

10. A system as in claim 1 wherein the care provider may selectively authorize and reject transactions initiated by the assisted person.

11. A system as in claim 1 wherein the care provider may initiate an order for an assisted person.

12. A system as in claim 1 wherein the system maintains a financial account associated with the assisted person from which to settle transactions initiated by the assisted person.

13. A system as in claim 12 wherein the system allows a person other than the assisted person to authorize replenishment of the financial account.

14. A system as in claim 1 further providing at least one portal for a vendor, said vendor portal providing capability for a vendor to respond to a request for a transaction.

15. A system as in claim 14 wherein a vendor portal provides capability for the vendor to communicate directly with an assisted person.

16. A system as in claim 14 wherein a vendor portal provides capability for a vendor to create an order for an assisted person.

17. A system as in claim 1 where an interface for the assisted-person includes a touch screen.
